(19) United States
(12) Patent Application Publication
(10) Pub. No.: US 2009/0216582 A1
(43) Pub. Date: Aug. 27, 2009

(54) SUB-LEDGER TO ACCOUNT FOR PERFORMANCE OBLIGATIONS

(75) Inventor: Seamus MORAN, Redwood City, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/037,833

(22) Filed: Feb. 26, 2008

(51) Int. Cl. G06Q 10/00

(52) U.S. Cl. 705/7

(57) ABSTRACT

A system and method for implementing a performance obligation sub-ledger. A performance obligation is generally the recognition by an enterprise that the enterprise has an obligation to provide goods and/or services that corresponds with the enterprise's right to receive consideration. The obligation is released as the goods and/or services are provided or other criteria are met. A performance obligation sub-ledger, which interacts with virtually all aspects of an enterprise management system is disclosed to keep track of creation and release of performance obligations. The summary of the performance obligation sub-ledger is then reflected in the enterprise general ledger.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates generally to systems of accounting, and in particular to a system for tracking performance obligations.

Traditional Enterprise Resource Management (ERM) systems begin with an order or a deal. This may be as simple as an exchange of cash for a tangible product or as complex as a multi-party, multi-year product and service contract. In either case, the entry of the order is a starting point. From there, two separate processes are spawned, with some linkage between them. This first of these process, sometimes referred to as Enterprise Resource Planning (ERP), deals with tasks the enterprise needs to accomplish in order to deliver the products or services to the entity that placed the order. The second of these processes, sometimes referred to as Customer Relationship Management (CRM), deals with tasks involving receiving payment from the customer for the products or services delivered.

Some typical task of an ERP system may consist of things such as supply management. This may be items such as ordering materials to build a product or scheduling staff to perform a service. In any case, it involves planning for resources necessary to fulfill the terms of the order or deal. At some point in the process, a completed product or service is delivered to the customer. The costs associated with delivering this product or service then must appear in the enterprises financial records, in order for the enterprise to know what the cost of producing the products or services was. This information eventually makes its way into the general ledger of the enterprise accounting system.

On the CRM branch of the process, there are tasks that need to be performed related to receiving payment for products or services provided. These may be things such as checking the credit worthiness of a customer, and general relationship management. At some point, the enterprise will be due payment from the customer. This point has typically been when an invoice is issued. Invoices may be issued when the product or service has actually been delivered, or they may be issued according to some other terms specified in the order or deal. Issuing an invoice usually involves some relationship with pricing, either from pricing tables or from the deal or order, and delivery. It has typically been at this point where the enterprise may record the amount due from the customer as an account receivable, reflected in the enterprise accounting system, with some additional conditions.

In an ideal world, a customer would pay an invoice as soon as it was received and would never return a product. Thus, the revenue associated with an invoice could immediately be recognized by the enterprise in its financial records. In realty, and as such reflected in the accounting standards, this is not the case. A customer may refuse to pay, may delay payment, or may return the product. Recognizing revenue upon issuance of an invoice could then result in misleading financial statements produced by the enterprise by over recognizing revenue for invoices that may never be realized. However, it would be equally misleading to wait until there is no possibility that revenue received from a customer will not need to be returned before recognizing the revenue.

Several mechanisms have been used in the past to try and reconcile this issue regarding revenue recognition. Among these have been recognizing the revenue immediately upon issuance of an invoice, but also recording an offsetting contingency to the revenue. This contingency has the effect of negating the recognized revenue. The contingencies may be released according to some defined schedule, depending on the particular business of the enterprise. For example, a retail business may use historical data to estimate the amount of returns it would expect and may release the contingencies based on the expected returns. Methods currently used to try to solve this problem have various disadvantages as is discussed elsewhere herein.

### BRIEF SUMMARY OF THE INVENTION

An exemplary embodiment provides a method for tracking performance obligations. The method stores information about an order into an order management system, where the order information may specify at least one performance obligation. An initial valuation for the performance obligation is recorded to a performance obligation sub-ledger. A remaining valuation for the performance obligation can be updated upon receiving information relating to at least a partial performance of the performance obligation. Additionally, the performance obligation can be released or otherwise accounted for when information corresponding to at least one obligation release criterion is received. The method may also include updating a general ledger upon release of the performance obligation.

A method for tracking performance obligations in accordance with another exemplary embodiment includes generating at least one performance obligation for an order, where the performance obligation may comprise a valuation for the performance obligation and at least one criterion for releasing at least a portion of the performance obligation. The valuation for the at least one performance obligation is recorded in a performance obligation sub-ledger. At least one criteria is also recorded for releasing at least a portion of the performance obligation. The method may reduce or adjust the valuation of the performance obligation in the performance obligation sub ledger based on the criteria. The method may also reflect the balance of the performance obligation sub ledger in a general ledger.

In yet another exemplary embodiment, a system is provided for tracking performance obligations. Such systems may include a processor, as well as a memory coupled to the processor, wherein the memory contains computer code that directs the processor to generate at least one performance obligation for an order, where the performance obligation comprises a valuation for the performance obligation and at least one criteria for releasing at least a portion of the performance obligation. The memory may further contain computer code for recording the valuation for the at least one performance obligation in a performance obligation sub ledger. The memory may also contain computer code for recording the at least one criteria for releasing the at least a portion of the performance obligation. Additionally, the memory may contain computer code for reducing the valuation of the at least one performance obligation in the performance obligation sub ledger based on the at least one criteria. The memory may also contain computer code for reflecting the balance of the performance obligation sub ledger in a general ledger.

In still another potential embodiment, a computer readable medium can have embodied on it a computer program that is executable by a machine to perform a method for tracking performance obligations. The program may further include computer code that directs the machine to generate at least one performance obligation for an order, where the performance obligation comprises a valuation for the performance obligation and at least one criteria for releasing at least a portion of the performance obligation. The program may further contain computer code for recording the valuation for the at least one performance obligation in a performance obligation sub ledger. The program may also contain computer code for recording the at least one criteria for releasing the at least a portion of the performance obligation. Additionally, the program may contain computer code for reducing the valuation of the at least one performance obligation in the performance obligation sub ledger based on the at least one criteria. The program may also contain computer code for reflecting the balance of the performance obligation sub ledger in a general ledger.

A further understanding of the nature and the advantages of the inventions disclosed herein may be realized by reference of the remaining portions of the specification and the attached drawings.

### BRIEF DESCRIPTION OF THE DRAWINGS

Various embodiments in accordance with the present invention will be described with reference to the drawings, in which:

FIG. 1 illustrates the process flow of an order through the supply and customer management activities of the prior art;

FIG. 2 illustrates a potential process flow of an order through the supply and customer management activities of the proposed new rules;

FIG. 3 illustrates one embodiment of a system used to track performance obligations;

FIG. 4 illustrates some of the potential interactions between various ERM systems necessary in order to manage performance obligations;

FIG. 5 illustrates components of a computer network that can be used in accordance with one embodiment of the present invention; and

FIG. 6 illustrates components of a computerized device that can be used in accordance with one embodiment of the present invention.

### DETAILED DESCRIPTION OF THE INVENTION

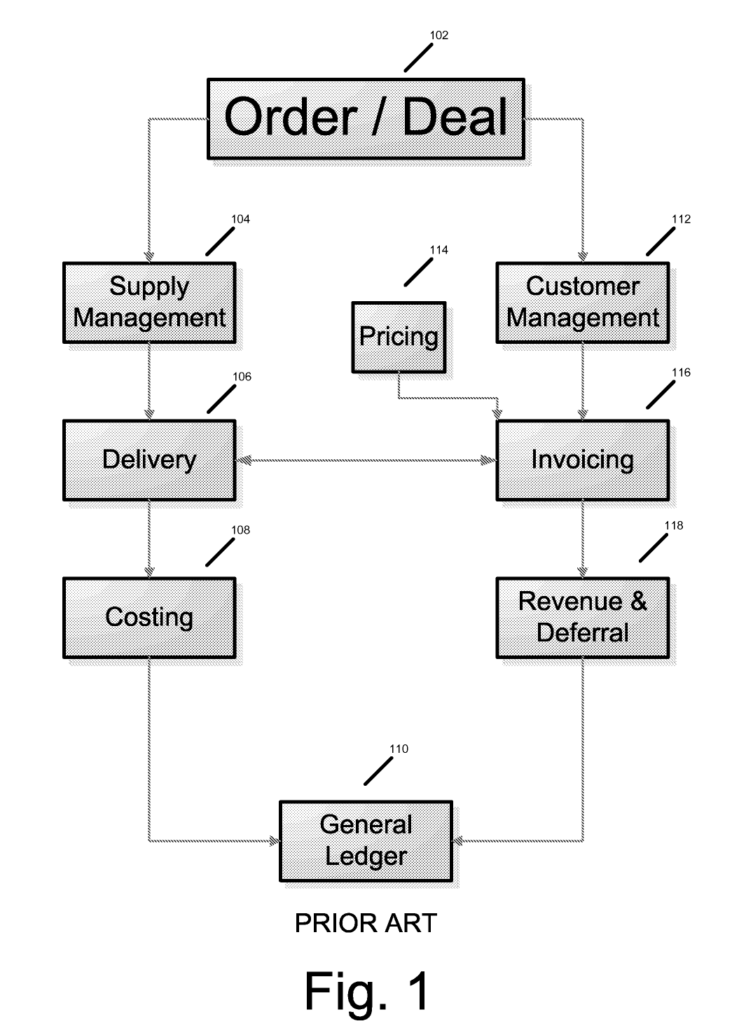

FIG. 1 is a high level overview of an Enterprise Resource Management (ERM) system as may exist today. While a number of modules are shown, it should be understood that these modules can be included on a single device or distributed across multiple devices. The modules also can be portion of code for a single application or multiple applications, or can be provided as services, etc. Further, the term “enterprise” is used generally, but it should be understood that advantages of the various embodiment can be obtained for any appropriate entity that handles orders or deals. Generally, the process begins with an order or deal (102). For purposes of simplicity the term “order” will be used herein for purposes of simplicity, but it should be understood that this can include any type of agreement, contract, or arrangement whereby parties agree for an exchange of some type of consideration. The order may be for goods, services, or a combination of both. The entry of the order into the ERM system triggers two separate, but somewhat related processes. The first of these processes involves the steps necessary to deliver the goods and/or services to a customer, and to reflect the costs associated with the delivery in the enterprise's general ledger. The second of these processes involves the steps necessary to receive payment from the customer for the goods and/or services and reflect this revenue in the enterprise's general ledger.

The customer delivery portion of the process generally begins at a supply management system (104). Tasks that fall within this system consist of activities necessary to fulfill the order. Such activities may include ordering raw materials to produce the goods to be sold, scheduling personnel and equipment to manufacturer those goods, or scheduling resources to satisfy deals related to services. At some point, the goods to be sold are completed, or the services to be provided are available, and the goods or services are delivered as tracked or recorded in a delivery module(106) to the customer to satisfy the order. Although the delivery process(es) may be quite large and complex, it is sufficient to abstract the delivery process(es) to show that at some point, the goods and services are delivered to the customer. At this point, the costs incurred in delivering the goods or services may be entered into a costing system (108), to reflect the expenses incurred by the enterprise in providing the goods or services. These costs will then be recorded in the enterprise's general ledger (110), in order to provide a portion of the complete picture of an enterprise's financial situation.

The customer payment portion of the process generally begins at a customer management system (112). These systems may record information about the customer, such as contact information, credit worthiness, or any other information related to a customer. The customer management system may also record information relating to the order (102) as entered into the system. At some point, the goods or services related to the order will be delivered to the customer. At this point, using data from a pricing system (114), an invoicing application (116) may issue an invoice requesting payment from the customer. Ideally, a customer would pay the invoice immediately and the payment would be recorded in a revenue and deferral system (118), for example, and the revenue would also then appear in the enterprise's general ledger (110). It is at this stage that the prior systems exhibit problems such as those mentioned above with regard to revenue recognition.

Once an invoice has been issued, the enterprise generally has a right to receive consideration (payment) for the goods or services provided. This right may be booked as an account receivable asset in the revenue system (118), and will appear in the enterprise's general ledger (110) as such. However, there can be problems with actually realizing this revenue, such as a customer refusing to pay, returning the merchandise, or disputes related to whether the order has been properly completed. If the revenue is booked immediately upon invoicing, it may cause the enterprise's general ledger to reflect an over reporting of revenue. On the other hand, if the revenue is deferred until the point that there is absolutely no chance the customer will dispute the payment, it will cause an under reporting of revenue.

Prior systems have attempted to overcome this problem by allowing revenue to be recognized as an account receivable immediately upon issue of an invoice. However, in addition to the recognized revenue, the enterprise would be required to book an offsetting amount in the form of a revenue contingency. The net result of this offsetting entry is that recognition of revenue will be deferred until the contingency is released. Rules for releasing the contingencies vary from industry to industry and even within enterprises within an industry. For example, a retailer may release contingencies based on historical data regarding a rate of product returns. A services supplier may release the contingencies based upon the length of a service contract, with some portion being released every month. Because of the multitude of ways revenue contingencies may be released, it creates a complex situation for persons who are reading an enterprise's financial statements and wish to compare one enterprise to another.

In an attempt to solve this problem, the accounting standards setting bodies have been developing a new method of recognizing revenue. Particulars of this method can be found in a proposal in a white paper generated by the International Accounting Standards Board. In essence, the standards body is proposing new rules that will allow an enterprise to recognize revenue fully and immediately at the point in time where they have the legal right to receive consideration (i.e., payment). This point has typically been the issuance of an invoice, but it could be any point as determined by the order. The new rules do not require recording an offsetting contingency to the revenue. Although this seems to result in the same situation as discussed above, the standards board has developed a new concept, called a performance obligation, to deal with those problems.

A performance obligation is the burden that is imposed on an enterprise in exchange for its right to receive consideration. For example, consider a deal to purchase a car that includes ten years worth of maintenance (the price of the maintenance being factored into the selling price of the car). Upon the closing of the deal, the seller has the legal right to obtain consideration (e.g. payment) in the amount of the sales price of the car. Under the new proposed rules, the seller would be able to recognize this revenue immediately, without restriction.

However, under the proposed rules, the seller would also be required to recognize that the seller has now incurred a performance obligation to the buyer of the car. In this example, the seller has obligated itself to provide: 1) the car itself, and 2) ten years worth of maintenance. This performance obligation would be recorded in the enterprise accounting system, and would offset the revenue that was immediately recognized when the deal was closed. As with the contingencies that were previously recorded, performance obligations would be released as certain conditions are met. The exact terms of when the performance obligations are released can be flexible and may vary from industry to industry. In the above car sales example, the performance obligation to deliver the car may be released when the car itself is delivered to the buyer. The performance obligation related to the ten years of maintenance may be released using one of many different schedules. Perhaps one tenth of the amount would be released each year, maybe it would be released based on each time the vehicle is brought in for maintenance, or it might be released according to some schedule based on predicted maintenance needs. The criteria used for releasing performance obligations can be very flexible.

As with the criteria for releasing performance obligations, the criteria for recording the value of the performance obligation can also be very flexible. In the simplest of cases, the value of the performance obligation may just be the same as the selling price. In more complicated cases, the value may be related to the current fair market value of the product or service that is to be delivered. The valuation of a performance obligation may vary from industry to industry, or even within an industry.

Regardless of how performance obligations are valued and released, an enterprise will require a mechanism for tracking the performance obligations and storing the rules used to release those performance obligations. The system will need to be in communication with almost all aspects of the ERM system. It will need to be tied in with order management systems, invoicing systems, customer delivery systems, and accounting systems in order to generate, update, and release performance obligations.

The proposal from the IASB regarding a new model for revenue recognition with a corresponding requirement to track performance obligations is focused on an accounting principles solution to the problem of accurate revenue recognition. Unfortunately, the proposal provides no guidance or requirements as to how these new accounting principals are to be implemented in currently existing ERM systems, how the data is to be structured, or how the data is to be reported. Embodiments of the present invention address implementation aspects of the proposed IASB principles, as well as other such aspects.

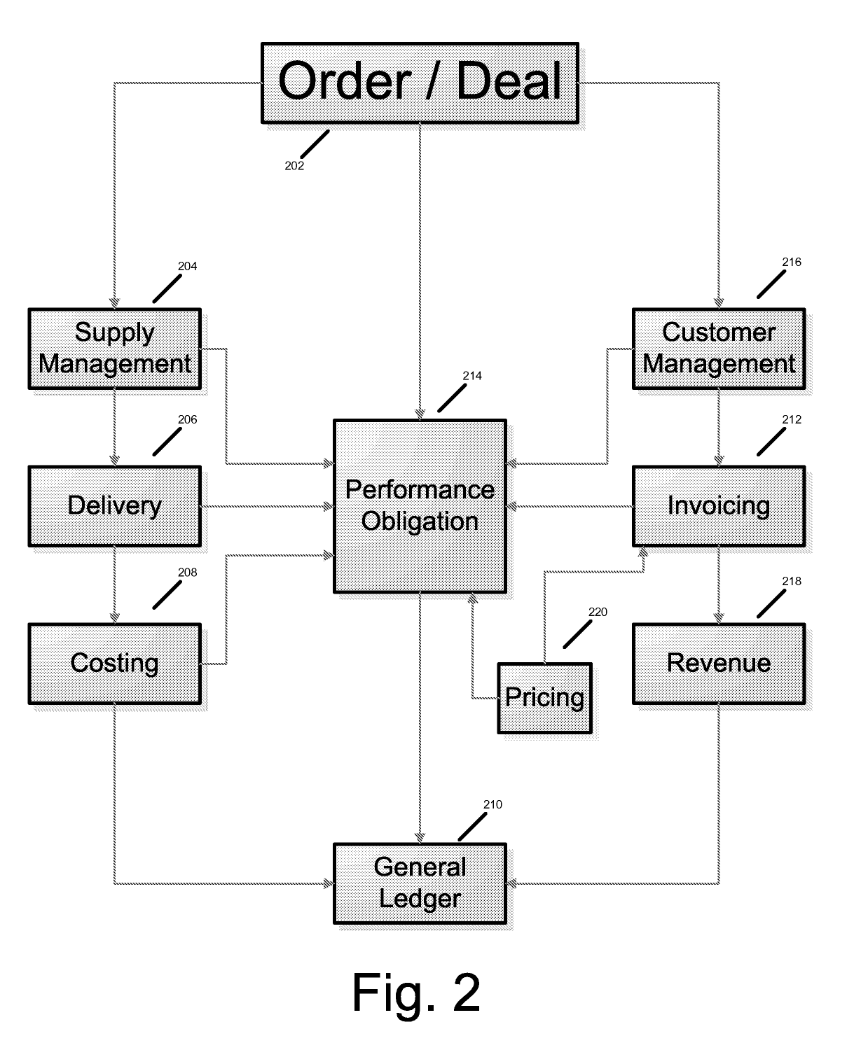

For example, FIG. 2 illustrates an exemplary process flow that can be used in an ERM or other system in accordance with one embodiment. Such a process addresses the aforementioned and other deficiencies in exiting systems, and further complies with the proposal by the International Accounting Standards Board (IASB) in an attempt to alleviate the revenue recognition problems inherent with prior systems. As in prior systems, entry into the system of an order (202) will cause at least one supply management process (204) to occur as in various prior systems. The customer delivery portion of the overall process is for the most part unchanged. The process eventually results in delivery to the customer, which is tracked or recorded in a delivery module or system (206). Again, at that point, costs associated with the delivery will be recorded, in this embodiments being recorded in a costing system (208) and a pricing system (220), although other approaches to recording associated costs can be used accordingly. These costs will eventually be reflected in the enterprise's general ledger (210). As in prior systems, the delivery module (206) in this embodiment will also provide an indication to an invoicing system (212) that an invoice for the order may be issued. In addition, the delivery module will also provide an indication to new performance obligation systems (214), which will be discussed in more detail below. As discussed above, the term “module” is used for sake of simplicity and explanation, and should not be construed as a limitation on the various embodiments, as functionality can be provided by various systems, devices, applications, services, and other such aspects as discussed elsewhere herein.

The customer payment portion of the process in this embodiment again generally begins with a customer management system (216), which receives information regarding the order. Rather than waiting for the delivery module (206) or invoicing module (212) to recognize revenue for the order, the revenue may be recognized in a revenue module (218) at any point where the enterprise has obtained the right to receive consideration. This can occur, for example, before or after delivery, before or after invoicing, or according to any other appropriate criteria as specified in the order. In addition to allowing revenue to be recognized at various points, such an approach does not require contingencies against that revenue to be recorded as in previous systems. At first glance, this would seem to result in a system that allows revenue to be recognized far in advance of if the revenue will ever be realized, and would result in potential over reporting of revenue by an enterprise. This potential problem is alleviated through the use of a new concept called a performance obligation, which can be recorded and tracked using an element such as a performance obligation module (214).

A performance obligation in at least one embodiment reflects a recognition that the right of an enterprise to receive consideration comes with a corresponding obligation for the enterprise to perform. Performance can include, for example, delivering goods, performing services, or a combination of both. An enterprise can record a performance obligation as a liability, which will eventually appear as such in the general ledger (210) of the enterprise. As such, recording of the performance obligation prevents immediate recognition of revenue without an offsetting recognition that the revenue may not be realized. In a similar fashion to releasing of revenue contingencies, performance obligations can also be released as the obligations are fulfilled.

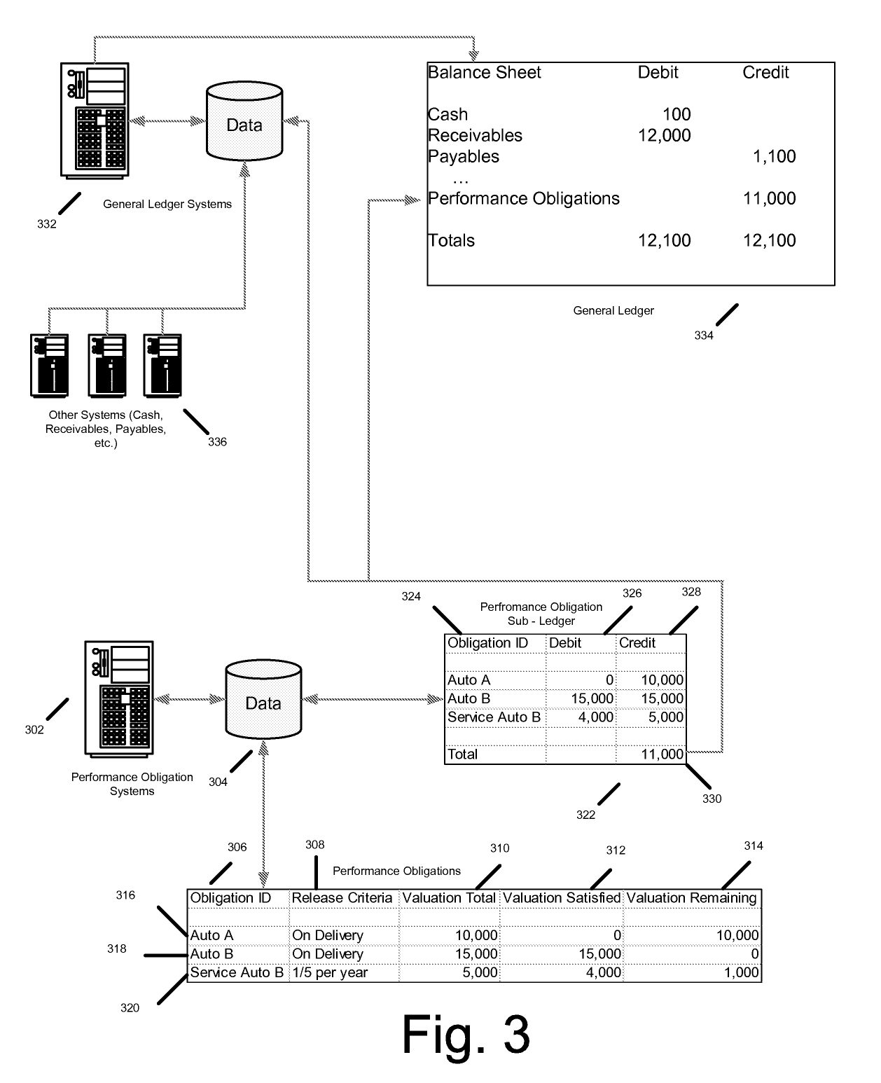

FIG. 3 illustrates an overview of an exemplary performance obligation management system that can be used in accordance with one embodiment. In this embodiment, a performance obligation management server (302) stores data related to performance obligations to be tracked in a database (304). There are many different items of data that may be associated with a performance obligation, which in this example include but are not limited to, an Obligation ID (306) to track individual obligations, Release Criteria (308) to store the rules for how a performance obligation is to be released, a valuation total (310) to indicate the original value of the performance obligation, a valuation satisfied (312) to indicate the amount of the performance obligation that has already been released, and a valuation remaining (314) to indicate the amount of the performance obligation that has yet to be released. The data in the performance obligation data table can be populated and modified through interactions with other systems, devices, or applications such as those described elsewhere herein. In the present example, there are three performance obligations stored. The first obligation (316) is for the sale of Auto A, and it is shown that the obligation is to be released on delivery, and the valuation of the obligation is 10,000. Because the valuation satisfied column is zero, it is clear that the release criteria has not been met, and the remaining value is the original valuation. A similar example can be followed with the obligation (318) for Auto B, with the difference being that the valuation total and valuation satisfied are equal, indicating the release criteria has been met. However, Auto B in this example was sold with a 5 year service plan, which also is recorded as an obligation (320). The valuation of that plan was determined to be 5,000, and the criteria for releasing the plan was decided to be to release ⅕ of the value each year. From the table, it is shown that currently 4,000 of the performance obligation has been satisfied, with 1,000 remaining.

The information stored in a performance obligation table can be further drilled down to details necessary from an accounting perspective. A performance obligation sub-ledger (322), for example, may be populated with data from the performance obligation table. In the example as shown, the three performance obligations listed have been reduced to the minimum amount of data that would be required in a performance obligation sub ledger. This data could include, but is not limited to, the obligation id (324) used to identify the obligation, the debit amount (326) associated with that obligation to indicate how much of the obligation has been satisfied, and a credit amount (328) which indicates how much of the obligation remains to be satisfied. The performance obligation sub-ledger, in addition to being useful for analysis of outstanding performance obligations, can also be summarized into a single entry, reflecting the total credit/debit balance of all performance obligations (330). This summarized data could then be used by a general ledger accounting system (332) to reflect the totals of the performance obligation sub-ledger (322) in the general ledger (334). This data, along with entries from any other appropriate system(s) (336), such as receivables, payables, and cash tracking systems, could then be used by general ledger systems to create a balance sheet for the enterprise.

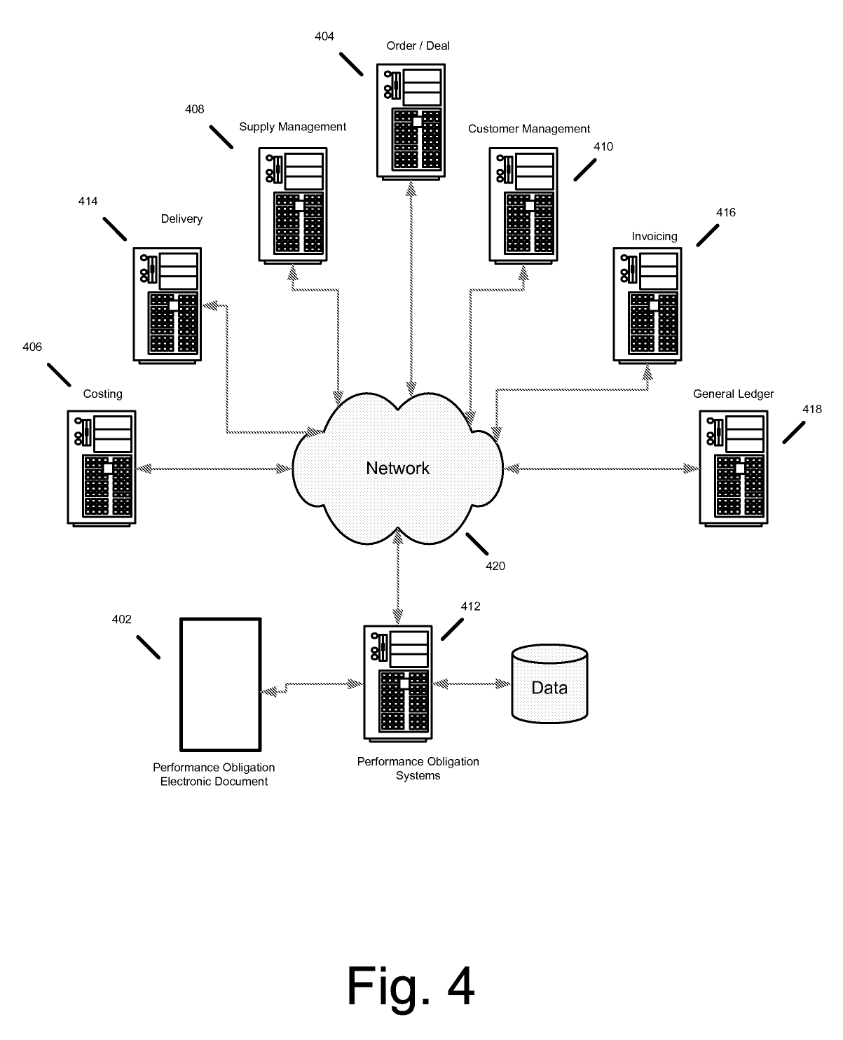

FIG. 4 illustrates some of the potential interactions between various ERM systems and components that can be used to manage performance obligations in one embodiment. This exemplary process begins with the creation of a performance obligation. This creation may begin with a performance obligation electronic document (402), or other such electronic entity such as an object or table entry, that will be used to record criteria related to the performance obligation. Information required to populate the electronic document may come from a wide variety of sources. For example, the document may initially be populated with information provided by an order entry system (404), to indicate that an order has been made, and the enterprise now has an obligation to perform. Information provided from a order entry system can include, for example, details such as what is being sold, the price it is being sold for, how it is to be delivered, and the criteria that will be used to release the performance obligation. It should be noted that a single order may cause more than one performance obligation to be generated.

In addition to interaction with order systems, there may also be interactions with systems or applications such as a costing system (406) and a supply management system (408), in order to determine the valuation for the performance obligation. This could include things such as price lists, actual costs to the enterprise of goods sold, or any variety of other criteria. Additionally there may be interactions with a customer management system (410), to reflect performance obligation release criteria that may be negotiated at a customer level, as opposed to an individual order level. It should be clear that the creation of a performance obligation may have interaction with any number of systems within an enterprise ERM system in order to accurately reflect the performance obligation incurred by the enterprise and the criteria necessary to fulfill those obligations, and the examples provided are by no means exhaustive.

Once a performance obligation has been created in a performance obligation system (412), that obligation typically will be maintained and eventually released within the system. Maintenance of a performance obligation may consist of reflecting current valuation of an existing obligation based on any number of criteria, such as changes in the current fair market value of the obligation. In addition, it could be based on changes in costing or supply, or from changes in the customer relationships as maintained in a customer management system (410). It should be clear that the examples provided in relation to maintaining a performance obligation are not exhaustive and performance obligation systems would interact with any number of systems within an ERM system in order to accurately reflect the current state and valuation of the performance obligations.

Release of performance obligations typically will also involve interactions with other systems within the ERM system. Some examples of this may be interactions with a delivery system (414) to indicate that goods have been delivered to the customer, and certain obligations may be released. There may also be interactions with a customer management system (410) when dealing with service contracts to reflect performance of services for a customer. There may be interactions with an invoicing system (416) to indicate that a customer has been billed for goods or services based on delivery. Again, it should be clear that the examples provided in relation to releasing a performance obligation are not exhaustive and performance obligation systems would interact with any number of systems within an ERM system in order to release performance obligations. Further, it should be understood that a system can include many components or instances, and that multiple systems can be used for individual systems discussed herein as would be apparent to one of ordinary skill in the art in light of the teachings and suggestions contained herein.

As was described in FIG. 3, any or all of the information stored in the performance obligations systems (412) can be used to analyze current performance obligations and to produce a performance obligation sub-ledger, which will eventually be reflected in the ERM systems general ledger as maintained by a ledger or other appropriate application or device (418). All of these various systems may be interconnected with any form of network (420) which are generally known in the art, such as those discussed elsewhere herein.

Although embodiments in the present figures depict various systems and data stores as discrete entities, it would be clear to a person of skill in the art that the embodiments could be implemented on single or multiple computing platforms with one ore more data stores. Examples of potential computing and data storage platforms usable in embodiments of the present invention are described below.

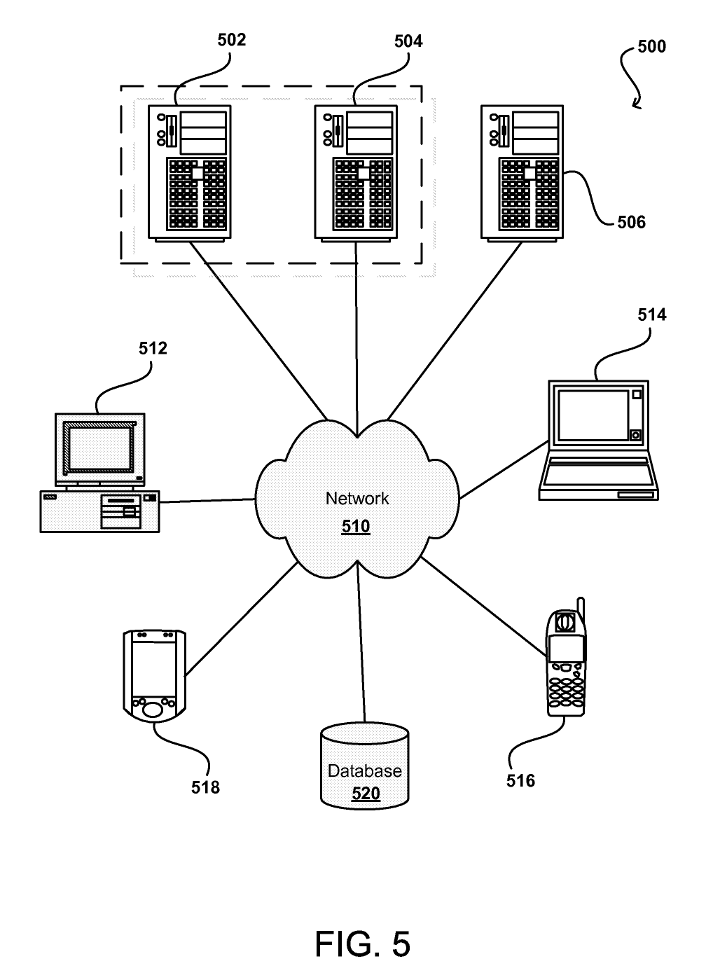

FIG. 5 is a block diagram illustrating components of an exemplary operating environment in which various embodiments of the present invention may be implemented. The system 500 can include one or more user computers, computing devices, or processing devices 512, 514, 516, 518, which can be used to operate a client, such as a dedicated application, web browser, etc. The user computers 512, 514, 516, 518 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 512, 514, 516, 518 may also have any of a variety of applications, including one or more development systems, database client and/or server applications, and Web browser applications. Alternatively, the user computers 512, 514, 516, 518 may be any other electronic device, such as a thin-client computer, Internet-enabled gaming system, and/or personal messaging device, capable of communicating via a network (e.g., the network 510 described below) and/or displaying and navigating Web pages or other types of electronic documents. Although the exemplary system 500 is shown with four user computers, any number of user computers may be supported.

In most embodiments, the system 500 includes some type of network 510. The network may can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2 G, 2.5 G, 3 G, 4 G, Wimax, WiFi, CDMA 2000, WCDMA, the Bluetooth protocol known in the art, and/or any other wireless protocol); and/or any combination of these and/or other networks.

The system may also include one or more server computers 502, 504, 506 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 506) may be dedicated to running applications, such as a business application, a Web server, application server, etc. Such servers may be used to process requests from user computers 512, 514, 516, 518. The applications can also include any number of applications for controlling access to resources of the servers 502, 504, 506.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 512, 514, 516, 518. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 512, 514, 516, 518.

The system 500 may also include one or more databases 520. The database(s) 520 may reside in a variety of locations. By way of example, a database 520 may reside on a storage medium local to (and/or resident in) one or more of the computers 502, 504, 506, 512, 514, 516, 518. Alternatively, it may be remote from any or all of the computers 502, 504, 506, 512, 514, 516, 518, and/or in communication (e.g., via the network 510) with one or more of these. In a particular set of embodiments, the database 520 may reside in a storage-area network (“SAN”) familiar to those skilled in the art. Similarly, any necessary files for performing the functions attributed to the computers 502, 504, 506, 512, 514, 516, 518 may be stored locally on the respective computer and/or remotely, as appropriate. In one set of embodiments, the database 520 may be a relational database, such as Oracle 10 g, that is adapted to store, update, and retrieve data in response to SQL-formatted commands.

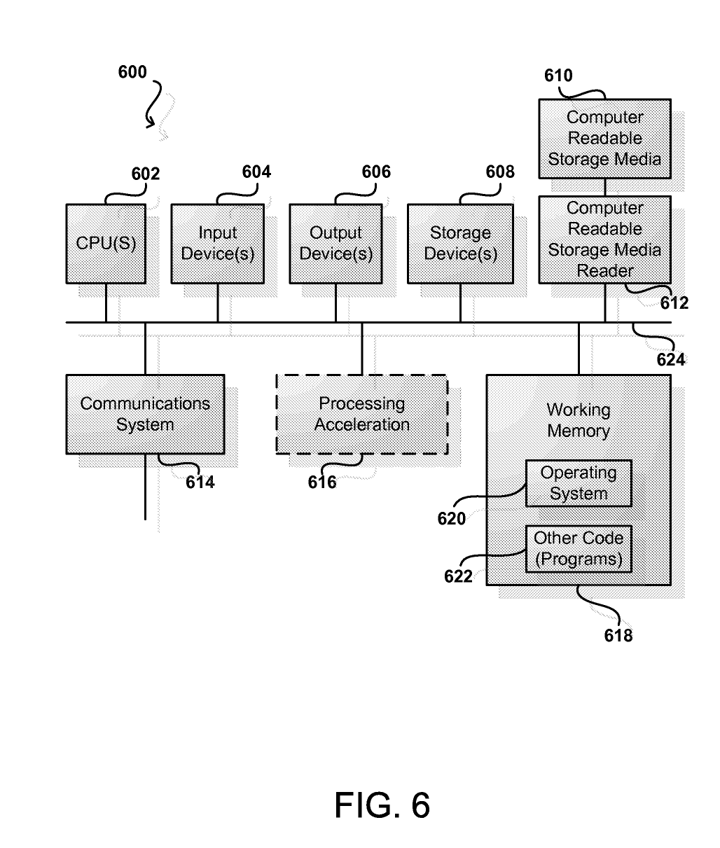

FIG. 6 illustrates an exemplary computer system 600, in which various embodiments of the present invention may be implemented. The system 600 may be used to implement any of the computer systems described above. The computer system 600 is shown comprising hardware elements that may be electrically coupled via a bus 624. The hardware elements may include one or more central processing units (CPUs) 602, one or more input devices 604 (e.g., a mouse, a keyboard, etc.), and one or more output devices 606 (e.g., a display device, a printer, etc.). The computer system 600 may also include one or more storage devices 608. By way of example, the storage device(s) 608 can include devices such as disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 612, a communications system 614 (e.g., a modem, a network card (wireless or wired), an infra-red communication device, etc.), and working memory 618, which may include RAM and ROM devices as described above. In some embodiments, the computer system 600 may also include a processing acceleration unit 616, which can include a digital signal processor DSP, a special-purpose processor, and/or the like.

The computer-readable storage media reader 612 can further be connected to a computer-readable storage medium 610, together (and, optionally, in combination with storage device(s) 608) comprehensively representing remote, local, fixed, and/or removable storage devices plus storage media for temporarily and/or more permanently containing, storing, transmitting, and retrieving computer-readable information. The communications system 614 may permit data to be exchanged with the network and/or any other computer described above with respect to the system 600.

The computer system 600 may also comprise software elements, shown as being currently located within a working memory 618, including an operating system 620 and/or other code 622, such as an application program (which may be a client application, Web browser, mid-tier application, RDBMS, etc.). It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method of tracking performance obligations, comprising:
storing order information into an order management system, the order information specifying at least one performance obligation;
recording a valuation for the performance obligation to a performance obligation sub-ledger;
updating a remaining valuation for the performance obligation upon receiving information relating to at least a partial performance of the performance obligation;
releasing the performance obligation when information corresponding to at least one obligation release criteria is received; and
updating a general ledger upon release of the performance obligation.

2. The method of claim 1, further comprising updating the remaining valuation for the performance obligation upon receiving information relating to revaluation of the performance obligation.

3. The method of claim 1, further comprising updating the at least one obligation release criteria.

4. The method of claim 1, wherein recording the valuation for the performance obligation comprises recording the valuation of the order.

5. The method of claim 1 further comprising updating the general ledger upon any change in the performance obligation sub-ledger.

6. A method of tracking performance obligations, comprising:
generating at least one performance obligation for an order, said performance obligation comprising a valuation for the performance obligation and at least one criteria for releasing at least a portion of the performance obligation;
recording the valuation for the at least one performance obligation in a performance obligation sub ledger;
recording the at least one criteria for releasing the at least a portion of the performance obligation;
reducing the valuation of the at least one performance obligation in the performance obligation sub ledger based on the at least one criteria; and
reflecting the balance of the performance obligation sub ledger in a general ledger.

7. The method of claim 6, further comprising maintaining the performance obligation, wherein maintaining the performance obligation comprises revaluation of the performance obligation.

8. The method of claim 6, further comprising maintaining the performance obligation, wherein maintaining the performance obligation comprises modifying the release criteria.

9. The method of claim 6, wherein the valuation of the performance obligation is equal to the valuation of the order.

10. The method of claim 6, wherein the criteria for releasing at least a portion of the performance obligation is satisfaction of the order.

11. The method of claim 6, wherein recording the valuation of at least one performance obligation in a performance obligation sub-ledger comprises recording a obligation identifier, an obligation credit amount, and an obligation debit amount.

12. A method of tracking performance obligations, comprising:
recording a performance obligation to a performance obligation sub-ledger;
applying an initial valuation to the recorded performance obligation;
updating a remaining valuation for the performance obligation upon receiving information relating to at least a partial performance of the performance obligation;
releasing the performance obligation when information corresponding to at least one obligation release criteria is received; and
updating a general ledger upon release of the performance obligation.

13. The method of claim 12, further comprising recognizing the valuation of the performance obligation based on at least one recognition criteria.

14. A system for tracking performance obligations, comprising:
a processor; and
a memory coupled to the processor for storing instructions executable by the processor, the memory including:
(i) computer code for generating at least one performance obligation for an order, wherein said performance obligation comprises a valuation for the performance obligation and at least one criteria for releasing at least a portion of the performance obligation,
(ii) computer code for recording the valuation for the at least one performance obligation in a performance obligation sub ledger,
(iii) computer code for recording the at least one criteria for releasing the at least a portion of the performance obligation,
(iv) computer code for reducing the valuation of the at least one performance obligation in the performance obligation sub ledger based on the at least one criteria, and
(v) computer code for reflecting the balance of the performance obligation sub ledger in a general ledger.

15. The system of claim 14 wherein the memory further comprises computer code for maintaining the performance obligation, wherein maintaining the performance obligation comprises revaluation of the performance obligation.

16. The system of claim 14 wherein maintaining the performance obligation comprises modifying the release criteria.

17. The system of claim 14 wherein the valuation of the performance obligation is equal to the valuation of the order.

18. The system of claim 14 wherein the criteria for releasing at least a portion of the performance obligation is satisfaction of the order.

19. The system of claim 14 wherein the memory comprising computer code for recording the valuation of at least one performance obligation in a performance obligation sub-ledger further comprises computer code for recording a obligation identifier, an obligation credit amount, and an obligation debit amount.

20. A computer-readable medium having embodied thereon a program, the program being executable by a machine to perform a method for tracking performance obligations, comprising:
generating at least one performance obligation for an order, said performance obligation comprising a valuation for the performance obligation and at least one criteria for releasing at least a portion of the performance obligation;
recording the valuation for the at least one performance obligation in a performance obligation sub ledger;
recording the at least one criteria for releasing the at least a portion of the performance obligation;
reducing the valuation of the at least one performance obligation in the performance obligation sub ledger based on the at least one criteria; and
reflecting the balance of the performance obligation sub ledger in a general ledger.

21. The program of claim 20, further comprising maintaining the performance obligation, wherein maintaining the performance obligation comprises revaluation of the performance obligation.

22. The program of claim 20, further comprising maintaining the performance obligation, wherein maintaining the performance obligation comprises modifying the release criteria.

23. The program of claim 20, wherein the valuation of the performance obligation is equal to the valuation of the order.

24. The program of claim 20, wherein the criteria for releasing at least a portion of the performance obligation is satisfaction of the order.

25. The program of claim 20, wherein recording the valuation of at least one performance obligation in a performance obligation sub-ledger comprises recording a obligation identifier, an obligation credit amount, and an obligation debit amount.
